(19) United States
(12) Patent Application Publication
(10) Pub. No.: US 2002/0092387 A1
(43) Pub. Date: Jul. 18, 2002

(54) Angle adjustable joint between a wrench head and a shank

(76) Inventor: Jack Lee, Jia Yi Hsien (TW)

Correspondence Address: Charles E. Baxley, Hart, Baxley, Daniels, & Holton, Fifth Floor, 59 John Street, New York, NY, 10038, US

(21) Appl. No.: 09/760,126

(22) Filed: Jan. 16, 2001

(51) Int. Cl. B25B 23/16

(52) U.S. Cl. 81/177.8

(57) ABSTRACT

A wrench tool includes a shank having two lugs and a recess is defined in the end of the shank and communicates with a receiving space between the two lugs. An operation member is rotatably received in the recess and has first teeth. A head has a connection port which is pivotally connected between the two lugs and the connection port has second teeth which are engaged with the first teeth of the operation member.

### FIELD OF THE INVENTION

The present invention relates to a wrench whose head has teeth engaged with a threaded operation member in the shank so that the head can be angle adjustable relative to the shank by rotating the operation member.

### BACKGROUND OF THE INVENTION

A conventional wrench is shown in FIG. 5 and generally includes a head 11 having a slot defined between lugs and an engaging member 10 is pivotally connected between the two lugs by a pin 100. A recess 14 is defined in an inner periphery defining the recess 14 so as to receive a spring 13 and a ball 12 therein. The ball 12 is pushed by the spring 13 to engage with an end of the engaging member 10. The engaging member 10 is then pivotable about the pin 100 and set at a angle by the engagement of the ball 12 and the end of the engaging member 10. Although the engaging member 10 can be set at different positions to meet the needs of the users, the engagement of the ball 12 and the end of the engaging member 10 is not secure enough so that the engaging member 10 is easily to slip when a force is applied to the engaging member 10. The users have to re-adjust the engaging member 10 again.

The present invention intends to provide an angle adjustable structure for a wrench head by using a threaded rod to engage with a toothed end of the engaging member.

### SUMMARY OF THE INVENTION

In accordance with one aspect of the present invention, there is provided a wrench tool and comprising a shank with two lugs extending from an end thereof and a recess defined in the end of the shank and communicating with a receiving space defined between the two lugs. An operation member is rotatably received in the recess and has first teeth. A head has a connection port which is pivotally connected between the two lugs and the connection port has second teeth which are engaged with the first teeth of the operation member. The head is set at an angle relative to the shank by rotating the operation member.

The primary object of the present invention is to provide a wrench whose head can be pivoted and securely set relative to the shank.

These and further objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is an exploded view to show a wrench tool of the present invention;

FIG. 2 is a perspective view to show the wrench tool of the present invention;

FIG. 3 is a cross sectional view to show that the-operation member is engaged with the connection port of the head of the wrench tool of the present invention;

FIG. 4 is a cross sectional view to show that the operation member is engaged with the connection port of the head when the shank of the wrench tool is rotated an angle, and

FIG. 5 is a cross sectional view to show a conventional wrench tool.

### DETAILED DESCRIPTION OF THE PREFERRED EMBODIMENT

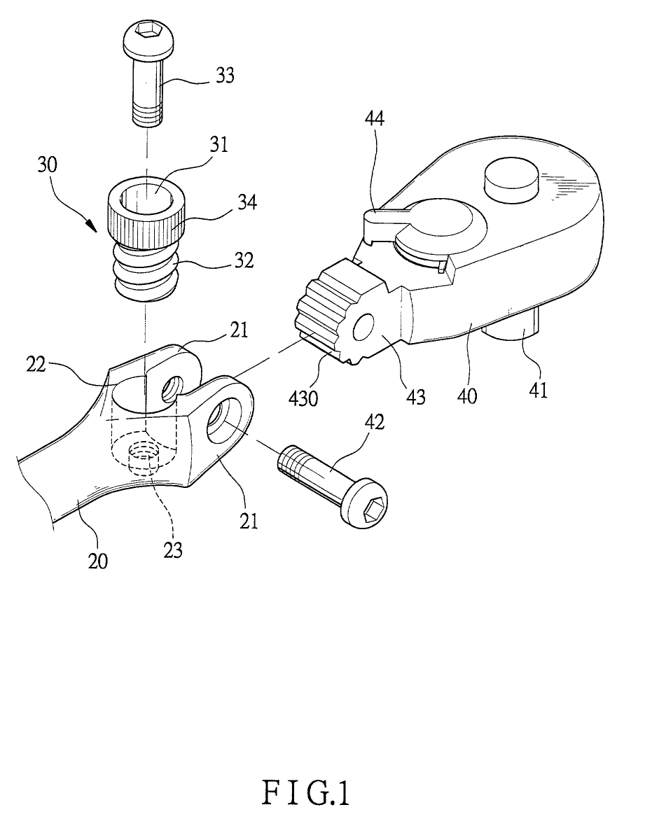

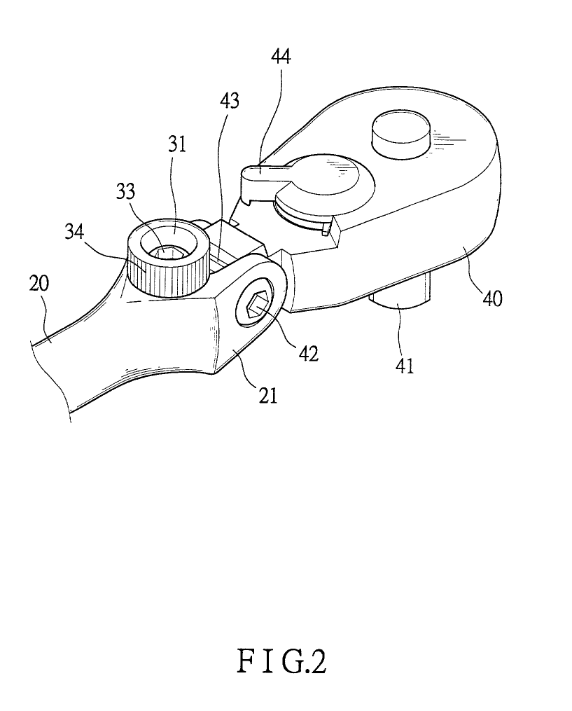

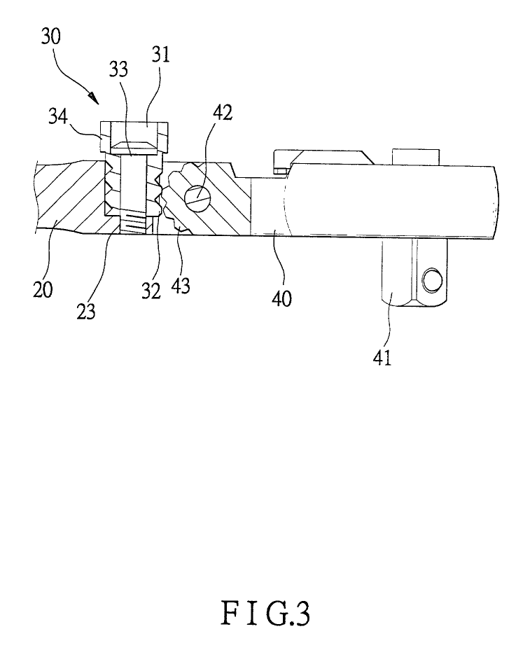

Referring to FIGS. 1 to 3, the wrench tool of the present invention comprises a shank 20 having two lugs 21 extending from an end thereof and a receiving space is defined between the two lugs 21. A recess 22 is defined in the end of the shank 20 and communicates with the receiving space. An operation member 30 is rotatably received in the recess 22 and has first teeth 32 defined in an outer periphery thereof. The operation member 30 has a passage 31 defined longitudinally therethrough and a threaded hole 23 is defined in an inner periphery defining the recess 22. A bolt 33 extends through the passage 31 of the bolt 33 and is engaged with the threaded hole 23. The operation member 30 has a section 34 located above a surface of the end of the shank 20 and the section 34 has a knurl surface for convenience of rotation.

A head 40 has a connection port 43 which is pivotally connected between the two lugs 21 by a pin 42 and the connection port 43 has second teeth 430 which are engaged with the first teeth 32 of the operation member 30. The head 40 has an engaging rod 41 extending therefrom and a ratchet mechanism (not shown) in the head 40 is control by a shifting lever 44 on the head 40.

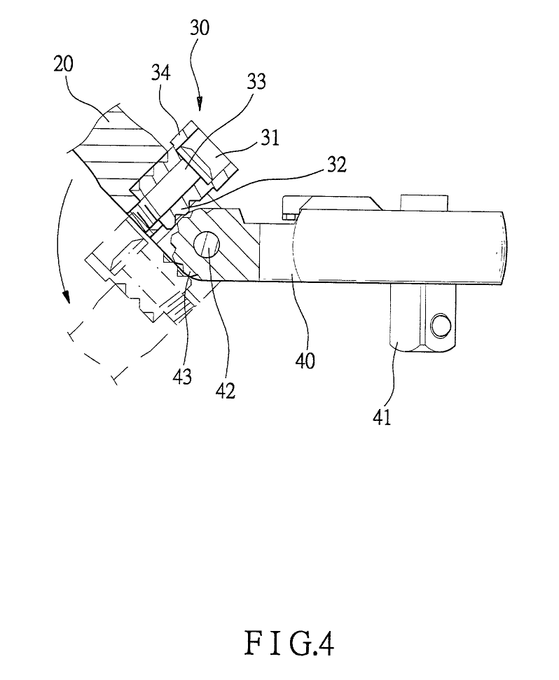

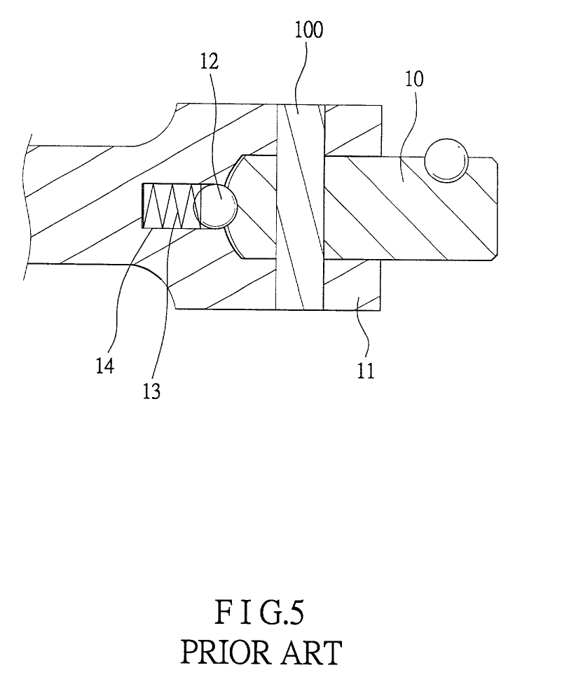

Referring to FIG. 4, an angle between the shank 20 and the head 40 can be changed or adjusted by rotating the operation member 30, the rotation of the operation member 30 rotates the connection port 43. The engagement between the first teeth 32 and the second teeth 430 is more secure compared with the ball 12 and the engaging member 10 as disclosed in FIG. 5 so that the head 40 will not slip during operation of the wrench tool.

While we have shown and described an embodiment in accordance with the present invention, it should be clear to those skilled in the art that further embodiments may be made without departing from the scope and spirit of the present invention.

What is claimed is:

1. A wrench tool comprising:
a shank having two lugs extending from an end thereof and a receiving space defined between said two lugs, a recess defined in said end of said shank and communicating with said receiving space, an operation member rotatably received in said recess and having first teeth defined in an outer periphery thereof, and
a head having a connection port which is pivotally connected between said two lugs by a pin and said connection port having second teeth which are engaged with said first teeth of said operation member.

2. The tool as claimed in claim 1, wherein said operation member has a passage defined longitudinally therethrough and a threaded hole is defined in an inner periphery defining said recess, a bolt extending through said passage of said bolt 33 and engaged with said threaded hole.

3. The tool as claimed in claim 1, wherein said operation member has a section located above a surface of said end of said shank.
